(19) United States
(12) Patent Application Publication
(10) Pub. No.: US 2004/0180592 A1
(43) Pub. Date: Sep. 16, 2004

(54) Thermoformable acoustic sheet material

(76) Inventor: Kyle A. Ray, Kentwood, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/437,356

(22) Filed: May 13, 2003

Related U.S. Application Data
(60) Provisional application No. 60/454,148, filed on Mar. 12, 2003.

(51) Int. Cl. B32B 27/04; B32B 3/04; B32B 27/12; B32B 33/00; B32B 3/02

(52) U.S. Cl. 442/38; 428/126; 428/85; 442/402; 442/394

(57) ABSTRACT

A multiple layer, thermoformable acoustic sheet material useful for manufacturing acoustic absorption, acoustic barrier and/or vibration damping components includes a barrier layer of synthetic fibers having an area weight of from about 40 grams per square foot to about 100 grams per square foot, and an absorber layer of vertically-lapped synthetic fibers, natural fibers or a combination of synthetic and natural fibers. The thermoformable acoustic sheet materials may include additional layers, with certain embodiments including an impermeable polymer film layer disposed between the barrier layer and the absorber layer.

### CROSS-REFERENCE TO RELATED APPLICATION

This application claims priority under 35 U.S.C. § 119(e) on U.S. Provisional Application No. 60/454,148 entitled THERMORFORMABLE ACOUSTIC SHEET MATERIAL, filed Mar. 12, 2003, by Kyle A. Ray, the entire disclosure of which is incorporated herein by reference.

### FIELD OF THE INVENTION

This invention relates to a thermoformable acoustic sheet material, and in particular to thermoformable multiple layer sheet materials that are lightweight and exhibit an outstanding combination of acoustic absorption, acoustic barrier, and/or vibration damping characteristics.

### BACKGROUND OF THE INVENTION

Thermoformable acoustic insulating and/or sound absorbing sheet materials are employed in substantially all mass produced motorized vehicles having a weather-tight passenger compartment. Thermoformability refers to the ability of the sheet material to be shaped in a molding tool under application of heat and, optionally, pressure, and subsequently retain the molded shape. It is highly desirable that the thermoformable acoustic sheet material used for molding sound insulating and/or sound absorbing panels for motorized vehicle applications has properties that impart resilience and flexibility to the finished panels. This combination of thermoformability, flexibility and resilience or shape-retention facilitates economical installation of the acoustic panel into the vehicle by allowing the panel to be bent during installation, such as to fit the panel into an obstructed space, without damaging or permanently deforming the shape of the panel, and by ensuring that the panel will conform as precisely as needed to the contours of a vehicle component without extensive laborious manipulation of the panel.

In addition to thermoformability, flexibility and resilience, all of which are important for achieving economical manufacturing and/or installation of the acoustic panel, there is a need for progressively thinner acoustic panels in order to maximize space availability for other vehicle components, passengers and cargo. Further, there is also a progressive need for lighter weight acoustic panels in order to minimize fuel consumption.

Accordingly, it is an object of this invention to provide a thermoformable acoustic sheet material that is flexible and resilient, thin, light in weight, low in cost, and exhibits outstanding acoustic absorption, acoustic barrier, and/or vibration damping properties.

### SUMMARY OF THE INVENTION

A multiple layer, thermoformable acoustic sheet material in accordance with this invention includes a barrier layer of synthetic fibers having an area weight of from about 40 grams per square foot to about 100 grams per square foot, and an absorber layer of vertically-lapped synthetic fibers, natural fibers or a combination of synthetic and natural fibers. The multiple layer, thermoformable acoustic sheet materials of this invention are useful for manufacturing acoustic absorption, acoustic barrier, and/or vibration damping components for various applications, especially in motorized vehicles such as automobiles and trucks.

These and other features, advantages and objects of the present invention will be further understood and appreciated by those skilled in the art by reference to the following specification, claims and appended drawings.

### BRIEF DESCRIPTION OF THE DRAWINGS

FIG. 1 is cross-sectional, diagrammatic view of a thermoformable acoustic sheet material including a barrier layer and an absorber layer.

FIG. 2. is a cross-sectional, diagrammatic view of a thermoformable acoustic sheet material including a barrier layer, an absorber layer, and a polymer film layer disposed between the barrier layer and the absorber layer.

FIG. 3 is a cross-sectional diagrammatic view of a thermoformable acoustic sheet material including a barrier layer, an absorber layer, and a scrim layer disposed between the barrier layer and the absorber layer.

FIG. 4 is a cross-sectional diagrammatic view of a vertically-lapped nonwoven fibrous mat that may be utilized in the thermoformable acoustic sheet materials of this invention.

### DESCRIPTION OF THE PREFERRED EMBODIMENTS

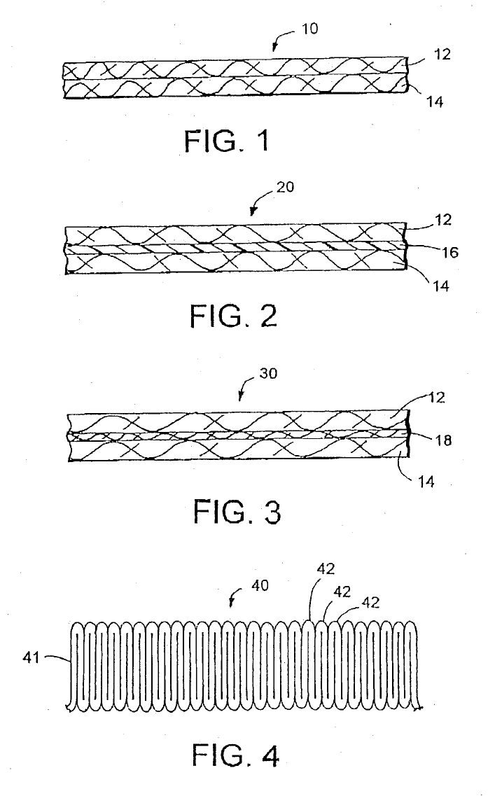

Shown in FIG. 1 is a thermoformable acoustic sheet material 10, which in accordance with the invention includes a barrier layer 12 of synthetic fiber having an area weight of from about 40 grams per square foot (about 430 grams per square meter) to about 100 grams per square foot (about 1076 grams per square meter) and a typical thickness of from about 1 millimeter to about 5 millimeters, and an absorber layer 14 of vertically-lapped synthetic fiber, natural fiber or a combination of synthetic and natural fiber, wherein the absorber layer has an area weight of from about 25 grams per square foot (about 270 grams per square meter) to about 100 grams per square foot (about 1076 grams per square meter) and a typical thickness of at least about 20 millimeters. The indicated thicknesses refer to the thickenesses of the layers of the thermoformable acoustic sheet material before it has been shaped or molded in a tool under application of heat and, optionally, pressure. After shaping or molding of the thermoformable acoustic sheet material, the layers 12, 14 will typically have variable thicknesses ranging up to the original thicknesses of the layers prior to thermoforming.

The thermoformable acoustic sheet materials of this invention include two or more layers, each layer having a length and width that is typically at least an order of magnitude greater than the thickness of the layer, which are attached to one another in overlapping relationships so that the total thickness is approximately the sum of the thicknesses of the individual layers. The thermoformable acoustic sheet materials of this invention are thermoformable sheet materials that exhibit sound insulative, sound absorptive, sound barrier, and/or other sound attenuative properties. In particular, the thermoformable acoustic sheet materials of this invention may be appropriately shaped or molded and installed between the engine compartment and the passenger compartment of a motor vehicle, and/or on the roof, floor, and/or doors of a vehicle to reduce the amount of engine and/or road noise in the passenger compartment of the motor vehicle.

The barrier layer is a relatively high density layer of nonwoven synthetic fiber that has been compressed to form a sheet or layer having an area weight of from about 40 grams per square foot to about 100 grams per square foot and a thickness of from about 1 millimeter to about 5 millimeters. The barrier layer typically exhibits excellent sound transmission barrier properties superior to that of the absorber layer. The barrier layer 12 may be vertically-lapped, air-laid, cross-lapped, needle-punched or the like.

The absorber layer is a relatively low density material that is typically lofted to achieve an area weight of from about 25 grams per square foot to about 100 grams per square foot for a thickness that is at least about 20 millimeters, more typically from about 20 to about 40 millimeters (prior to thermoforming of the acoustic sheet material). The absorber layer exhibits superior sound absorptive properties as compared with the barrier layer.

The barrier layer and the absorber layer may be attached to one another either directly, such as by needle-punching through the layers so that fibers in at least one of the layers penetrate into and become intertwined with fibers in the other layer, or indirectly, such as with a polymer film layer disposed between, and bonded to each of, the barrier layer and the absorber layer.

It has been discovered that a highly efficient absorber layer that is lightweight and relatively thin can be achieved by utilizing vertically-lapped synthetic fiber, natural fiber or a combination of synthetic and natural fiber. The vertically-lapped fibrous layer has been shown to provide improved sound absorption as compared with a conventional high loft material using the same fibers and same weight and/or density. A vertically-lapped fibrous layer or batt is a nonwoven fibrous layer or batt that has been repeatedly folded back and forth onto itself (i.e., pleated) to produce a vertically folded sheet material in which the fibers are predominantly or at least preferentially oriented with the length direction of the fibers being parallel with the thickness direction of the layer or batt. Vertically-lapped nonwoven materials are also referred to as variable compression fabric. Vertically-lapped materials may be produced by utilizing standard textile fiber blending equipment (if a mixture of fibers is used) and standard textile carding equipment to form a nonwoven web. The carded nonwoven web is then fed into a vertical lap machine which folds the web back onto itself to form a vertically-lapped or pleated structure. The vertical laps are preferably thermally bonded together, such as by using a flatbed conveyor convection oven. A vertically-lapped nonwoven fibrous mat that may be employed in the thermoformable sheet materials of this invention is shown in FIG. 4. The illustrated vertically-lapped nonwoven fibrous mat 40 comprising a carded fiber web 41 that is repeatedly folded upon itself to form a multiplicity of adjacent vertical laps or pleats 42. This vertically-lapped structure is utilized in the absorber layer 14 of each of the embodiments illustrated in FIGS. 1, 2 and 3, and may be employed in the barrier layer 12.

It has also been discovered that a vertically-lapped synthetic fiber may be advantageously, but not necessarily, employed in the barrier layer 12.

The fibrous layers used in the thermoformable acoustic sheet materials of this invention may be prepared using any suitable technique, such as conventional dry-laid web formation processes, including carding, air-laying, etc. The resulting webs may be further processed, i.e., vertically-lapped, cross-lapped, needle-punched, thermal bonded, hydroentangled, chemically bonded, etc.

FIG. 2 shows another embodiment of the invention wherein a polymer film layer 16 is disposed between barrier layer 12 and absorber layer 14. Polymer film 16 is a relatively thin, substantially continuous sheet of material comprising a polymer. The polymer film may be conveniently used for adhesively attaching barrier layer 12 and absorber layer 14 together. This may be achieved by utilizing a polymer film 16 having a pressure sensitive adhesive disposed on the opposite sides of the film. Alternatively, polymer film 16 may be used as a hot melt adhesive for bonding layers 12 and 14 together. Alternatively, or in addition, polymer film 16 may be used for enhancing the acoustic barrier properties of thermoformable acoustic sheet material 20. While there is not a precise upper or lower limit for the thickness of polymer film 16, polymer film 16 may typically have a thickness of from about 1 to 20 mils. However, it is possible to use thinner and/or thicker films if desired. Suitable polymer films include polyolefin films (e.g. polyethylene), polyethylene terephthalate films, etc. An example of a commercially available polymer film that may be used is INTEGRAL™ 906 polyolefin multilayer adhesive film, which is an impermeable film available from the Dow Chemical Company. In this embodiment, the layers 12 and 14 may each, independently comprise vertically-lapped, air-laid, cross-lapped, needle-punched or other nonwoven fibrous arrangements.

Contrary to common belief and practice, it has been discovered that thermoformable sheet materials having excellent acoustic barrier/absorption properties can be prepared by combining fibrous layers with an impermeable polymer film. Permeable polymer films and scrims have been used in the manufacture of thermoformable acoustic sheet materials to impart improved sound absorption properties and to shift the frequency at which peak absorption occurs, i.e., tune the barrier for a particular application. It was previously believed that the polymer film or scrim must be permeable or be made permeable in order to achieve the desired sound barrier/absorption properties. The use of an impermeable film between fibrous layers has the advantage of providing a lower cost thermoformable sheet material having excellent acoustic barrier/absorption properties as compared with known thermoformable acoustic sheet materials having a permeable scrim or perforated polymer film layer. This is due to the fact that spun-bonded filament and other scrims, as well as perforated films, require more complicated and expensive manufacturing processes. The term “impermeable film” as used herein means a film that has an airflow resistance not less than about 5000 Rayls.

In accordance with another embodiment of the invention, a thermoformable acoustic sheet material 30 comprising a barrier layer of synthetic fiber 12, an absorber layer of vertically-lapped synthetic fiber, natural fiber or a combination of synthetic and natural fiber, and a scrim 18 between the barrier layer and the absorber layer is shown in FIG. 3. A scrim is a relatively thin and durable woven fabric which may be comprised of synthetic or natural fibers. Scrim layer 18 may be used for attaching layers 12 and 14 together, such as by applying an adhesive to opposite sides of scrim 18 before disposing scrim 18 between layers 12 and 14. The use of scrim layer 18 in thermoformable acoustic sheet material 30 has been found to enhance acoustic absorption properties.

The thermoformable acoustic sheet materials of this invention may be utilized in the manufacture of acoustic insulative carpet systems. In this case, barrier layer 12 comprises a carpet. For example, a latex backed carpet (e.g., 12 ounce of latex per square yard of carpet) was attached to a lofted, vertically-lapped polyester (polyethylene terephthalate) layer having a area weight of from about 60 grams per square foot to about 100 grams per square foot, a thickness of about 35 millimeters, and an airflow resistance of less than 100 Rayls, to provide a lightweight, relatively thin, economical carpet system exhibiting outstanding sound insulative properties. Airflow resistance may be determined in accordance with ASTM C522-87, “Standard Test Method for Airflow Resistance of Acoustic Materials.”

In order to provide a thermoformable acoustic sheet material, the barrier layer may be formed of synthetic fibers that may be thermally fused together during a thermoforming operation to provide a flexible, resilient finished product conforming to the contours of a vehicle component to which the shaped product is to be mounted. Suitable fibers for imparting thermoformability include various thermoplastic fibers that can be softened and/or partially melted upon application of heat during a thermoforming process to form a multiplicity of bonds at fiber-fiber intersections to impart flexible and resilient shape retention properties. Examples of suitable thermoplastic fibers include fibers comprised of homopolymers and copolymers of polyester, nylon, polyethylene, polypropylene and blends of fibers formed from these polymers and copolymers. Particularly suitable are composite or bicomponent fibers having a relatively low melting binder component and a higher melting strength component. Bicomponent fibers of this type are advantageous since the strength component imparts and maintains adequate strength to the fiber while the bonding characteristics are imparted by the low temperature component. A variety of bicomponent fibers of this type are commercially available from various sources. One suitable fiber for use in the present invention is a sheath-core bicomponent construction wherein the core is formed of a relatively high melting polyethylene terephthalate (PET) polymer and the sheath comprises a PET copolymer having a lower melting temperature which exhibits thermoplastic adhesive and thermoformability properties when heated to a temperature of about 170 to 200° C.

In many applications, suitable thermoformability may be imparted by using synthetic thermoplastic fibers in the barrier layer, while using all natural fibers, or a combination of natural and synthetic fibers in the absorber layer. However, in certain applications, it may be desirable to utilize synthetic thermoplastic fibers in both the barrier layer and the absorber layer. If desired, natural fibers may also be employed in the barrier layer, provided that it includes a sufficient amount of thermoplastic fibers to impart thermoformability. Natural fibers that may be employed include hemp fibers, linen fibers, flax fibers, jute fibers, kenaf, sisal, mixtures thereof, and the like.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A thermoformable acoustic sheet material comprising:
a barrier layer of synthetic fiber having an area weight of from about 40 grams per square foot to about 100 grams per square foot; and
an absorber layer of vertically-lapped synthetic fiber, natural fiber or a combination of synthetic and natural fiber, the absorber layer having an area weight of from about 25 grams per square foot to about 100 grams per square and a thickness of at least about 20 millimeters.

2. The thermoformable acoustic sheet material of claim 1, further comprising a polymer film layer disposed between the barrier layer and the absorber layer.

3. The thermoformable acoustic sheet material of claim 1, further comprising a scrim layer disposed between the barrier layer and the absorber layer.

4. The thermoformable acoustic sheet material of claim 1, wherein the barrier layer has an airflow resistance from about 200 to about 300 Rayls.

5. The thermoformable acoustic sheet material of claim 1, wherein the absorber layer has an airflow resistance less than 100 Rayls.

6. The thermoformable acoustic sheet material of claim 1, wherein the barrier layer is a carpet.

7. The thermoformable acoustic sheet material of claim 1, wherein the synthetic fibers of the barrier layer are vertically-lapped, air-laid, cross-lapped, or needle-punched.

8. The thermoformable acoustic sheet material of claim 1, wherein the synthetic fibers are comprised of polyethylene terephthalate.

9. The thermoformable acoustic sheet material of claim 1, wherein the synthetic fibers of the barrier layer are vertically-lapped, the barrier layer has an airflow resistance of from about 200 to about 300 Rayls, and the absorber layer has an airflow resistance of less than 100 Rayls.

10. The thermoformable acoustic sheet material of claim 1, further comprising an impermeable polymer film disposed between the barrier layer and the absorber layer.

11. The thermoformable acoustic sheet material of claim 1, wherein the barrier layer is a carpet, the absorber layer is a vertically-lapped fiber layer having an airflow resistance of less than 100 Rayls, and the absorber layer and barrier layer are attached to one another without an intervening polymer film or scrim layer.

12. A molded acoustic panel made of the thermoformable acoustic sheet material of claim 1.

13. A vehicle including the molded acoustic panel of claim 12.

14. The vehicle of claim 13, wherein the molded acoustic panel is a dash acoustic insulation panel, an acoustic carpet system, an acoustic insulating trunk underlayment, a wheel house acoustic insulation panel, or a door acoustic insulation panel.

15. A thermoformable acoustic sheet material comprising:
a barrier layer of synthetic fiber having an area weight of from about 40 grams per square foot to about 100 grams per square foot;
an absorber layer of fiber having an area weight of from about 25 grams per square foot to about 100 grams per square foot and thickness of at least about 20 millimeters; and
an impermeable polymer film layer disposed between the barrier layer and the absorber layer.

16. The thermoformable acoustic sheet material of claim 15, wherein the barrier layer has an airflow resistance from about 200 to about 300 Rayls.

17. The thermoformable acoustic sheet material of claim 15, wherein the absorber layer has an airflow resistance less than 100 Rayls.

18. The thermoformable acoustic sheet material of claim 15, wherein the synthetic fibers of the barrier layer are vertically-lapped, the barrier layer has an airflow resistance of from about 200 to about 300 Rayls, and the absorber layer has an airflow resistance of less than 100 Rayls.

19. The thermoformable acoustic sheet material of claim 15, wherein the polymer film layer is impermeable.

20. A molded acoustic panel made of the thermoformable acoustic sheet material of claim 15.

21. The thermoformable acoustic sheet material of claim 15, wherein the impermeable polymer film layer is polyolefin film having an airflow resistance not less than 5000 Rayls.
